(19) United States
(12) Patent Application Publication
(10) Pub. No.: US 2010/0307059 A1
(43) Pub. Date: Dec. 9, 2010

(54) HOLLOW CORE SCREEN DOOR

(76) Inventor: PHILIP J. OBERBROECKLING, P.E., Kingwood, TX (US)

Correspondence Address: James Ray & Associates, 2640 Pitcairn Road, Monroeville, PA, 15146, US

(21) Appl. No.: 12/478,859

(22) Filed: Jun. 5, 2009

(51) Int. Cl. E06B 3/26; E04C 2/36

(52) U.S. Cl. 49/61; 52/784.1

(57) ABSTRACT

The present invention is a hollow core screen door with the screen opening in the upper half of the door. In several embodiments the door is constructed to fit in a standard interior doorway without modifying the existing doorway frame. In several embodiments the screen is constructed in a modular frame for easy replacement of the screen if damaged or if other material such a glass or plexiglass is desired in the screen opening. In several embodiments the modular screen frame can be replaced without tools.

### FIELD OF THE INVENTION

This invention generally pertains to hollow core doors. More specifically, the present invention relates to a hollow core door with a replaceable screen in the upper half of the door.

### BACKGROUND OF THE INVENTION

The invention is particularly applicable to interior hollow core doors and will be described with particular reference thereto. However, it will be appreciated by those skilled in the art that the invention has broader applications and may also be adapted for use as an exterior door, tree house door, or other door applications.

While screen doors have been made of solid core materials, as described in U.S. Pat. No. 6,250,040, none have used hollow core materials. Additionally, none of the screen doors have been designed to fit in a standard home interior 80 inch tall door frame designed to hold a 1⅜ inch thick door and would require onsite alterations to properly fit and be properly secured in said standard interior door ways.

Hollow core doors often consist of a core of lattice or honeycomb made of corrugated cardboard, or thin wooden slats. They can also be built with staggered wooden blocks. The external shell of the door is press-mold fabricated using compressed paper/wood bonded or hard plastic materials or other similar materials allowing for aesthetic designs such as panels. Hollow-core doors are commonly used as interior doors. Compared to solid core doors, they are lighter, cost less to manufacture, durable (scratch resistant) and easier to install.

Accordingly, it has been considered desirable to develop a new and improved hollow core door containing a screen opening (or glass or acrylic glass as alternates) in the upper half to be used in new construction or as a replacement for an existing hollow core door which would overcome the foregoing difficulties and others while providing better and more advantageous overall results.

### SUMMARY OF THE INVENTION

The present invention is a hollow core screen door. In several embodiments the door is constructed to fit in a standard interior doorway without modifications to the existing door frame. In several embodiments the screen opening is constructed in the upper half of the door. In several embodiments the screen is constructed in a modular frame for easy replacement of the screen if damaged or if other material such a glass or acrylic glass is desired in the screen opening. In several embodiments the modular screen frame can be replaced without tools.

There are numerous possible uses for the present invention. It is envisioned that the present invention could be used as a nursery door to keep unwanted pets or other children from entering the nursery while maintaining an “open” effect of the said room to the home environment. The advantage being that one could still easily hear the infant, and even see the infant but keep unwanted pets away from said infant. The other advantage is that the present invention allows the infant to become acclimated to background noise in the home environment through the “open” effect to develop improved sleeping habits yet is still protected from pets and other children. It is also beneficial to have an easily replaceable screen so that if the screen is damaged by a pet or child it can be quickly replaced. The present invention also has an aesthetically pleasing appearance that has a common pattern matching all other interior doors in a home (house or apartment). Additionally, the present invention fits into the existing interior door frame without alterations allowing for the door to be quickly switched back to the original door when desired. The present invention can be used in a multitude of other applications such as game rooms, TV rooms or computer rooms where viewing of or listening to the activities in the said room is desired.

### OBJECTS OF THE INVENTION

It is, therefore, one of the primary objects of the present invention to provide a door with a modular screen frame.

Another object of the present invention is to provide a hollow core door with a modular screen frame in the upper half of the door.

Still another object of the present invention is to provide a hollow core door with a modular screen frame in the upper half of the door that can be replaced without the use of tools.

Yet another object of the present invention is to provide a hollow core door with a modular screen frame in the upper half of the door for use as a nursery door or in numerous other applications in the home environment.

In one embodiment the invention is a door comprising: a hollow core, an opening in said door, a modular frame for installation into said opening, wherein said modular frame is installed into said opening by a plurality of fasteners. In another embodiment said modular frame holds a mesh screen. In yet another embodiment said modular frame holds a section of glass. In still yet another embodiment said modular frame holds a section of acrylic glass. In yet still another embodiment said plurality of fasteners comprises at least one L-screw. In another embodiment said plurality of fasteners comprises at least one roller latch and at least one clip. In another embodiment said plurality of fasteners comprises at least one roller latch, at least one clip, and at least one pin. In another embodiment said plurality of fasteners comprises at least one roller latch, at least one clip, at least one screw and at least one pin. In another embodiment said modular frame is installed into said opening without tools by placing said modular mesh screen frame into said opening. In yet still another embodiment said opening in said door is located in upper half portion of said door.

In another example embodiment the invention is a hollow core door comprising: an opening in said hollow core door, a modular mesh screen frame for installation into said opening, wherein said modular mesh screen frame is installed into said opening by a plurality of fasteners. In another embodiment said plurality of fasteners comprises at least one L-screw. In yet another embodiment said plurality of fasteners comprises at least one roller latch and at least one clip. In still another embodiment said plurality of fasteners comprises at least one roller latch, at least one clip, and at least one pin. In yet still another embodiment said plurality of fasteners comprises at least one roller latch, at least one clip, at least one screw and at least one pin. In still yet another embodiment said modular mesh screen frame is installed into said opening without tools by placing said modular mesh screen frame into said opening. In yet still another embodiment said opening in said door is located in upper half portion of said door.

It is to be understood that both the foregoing general description and the following detailed description are merely exemplary of the invention, and are intended to provide an overview or framework for understanding the nature and character of the invention as it is claimed. The accompanying drawings are included to provide a further understanding of the invention, and are incorporated in and constitute a part of this specification. The drawings illustrate various embodiments of the invention; and together with the description serve to explain the principles and operation of the invention.

### BRIEF DESCRIPTION OF THE DRAWINGS

FIG. 1 is an assembled view of one embodiment of the present invention.

FIG. 2 is a rear view and side view of an embodiment of a modular screen frame.

FIG. 3 is a disassembled view of one embodiment of a hollow core screen door.

FIG. 4 is a detailed view of an embodiment of a roller latch and associated clip.

FIG. 5 is a detailed perspective view of an L-screw for securing a modular screen frame.

FIG. 6 is a schematic view of an L-screw being used for securing a modular screen frame to a hollow core door.

### BRIEF DESCRIPTION OF A PRESENTLY PREFERRED AND VARIOUS ALTERNATIVE EMBODIMENTS OF THE INVENTION

Prior to proceeding to the more detailed description of the present invention it should be noted that, for the sake of clarity and understanding, identical components which have identical functions have been identified with identical reference numerals throughout the several views illustrated in the drawing figures.

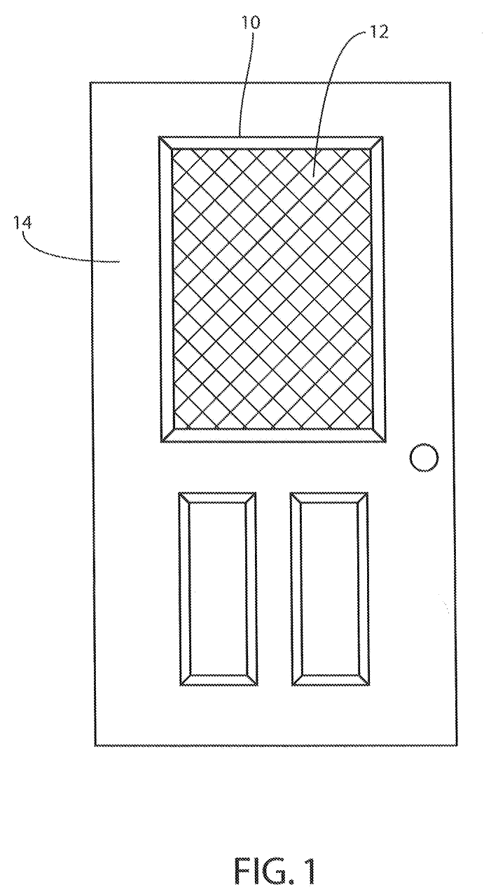

Reference is now made to FIGS. 1-4, more particularly, to FIG. 1 which is an assembled view of one embodiment of the present invention. Modular screen frame 10 with mesh screen 12 is seated in hollow core door 14.

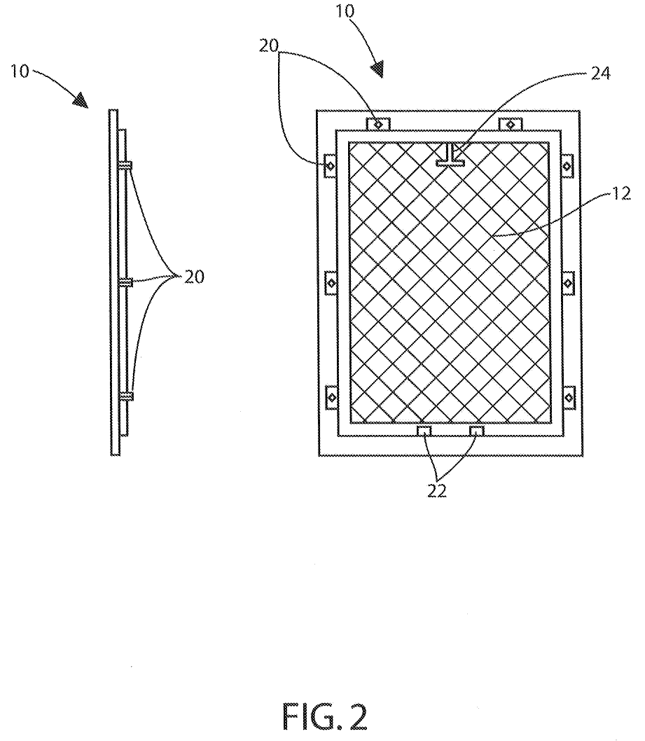

Particular reference is now made to FIG. 2 which is a rear view and side view of an embodiment of a modular screen frame. Modular screen frame 10 with mesh screen 12 is shown with a plurality of clips 20. Modular screen frame 10 also has pin holes 22 for accepting associated pins. Optionally, a safety screw 24 can be used for securing the modular screen frame 10 to hollow core door 14.

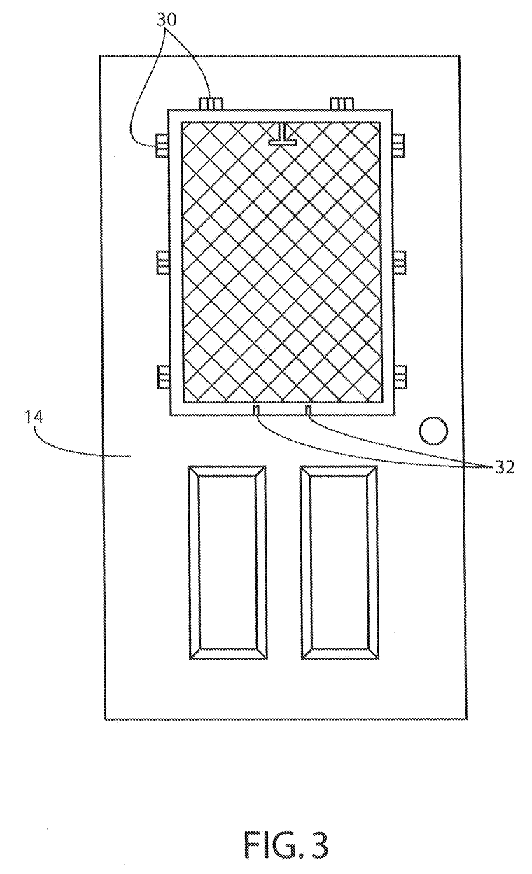

Particular reference is now made to FIG. 3 a disassembled view of one embodiment of a hollow core screen door that could be used with modular screen frame 10 as shown in FIG. 2. Hollow core door 14 includes roller latches 30 for accepting clips 20 of modular screen frame 10. Hollow core door 14 also includes pins 32 which are accepted by pin holes 22 in modular screen frame 10.

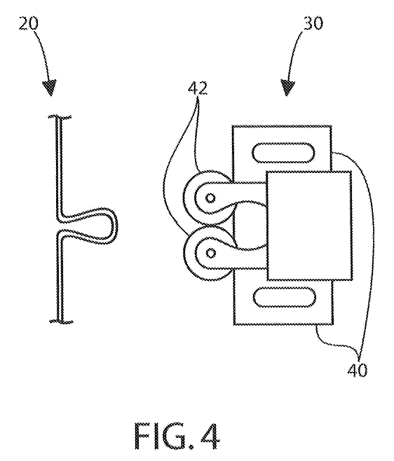

Particular reference is now made to FIG. 4 a detailed view of an embodiment of a roller latch 30 and associated clip 20. Roller latch 30 comprises bracket 40 for mounting to interior of hollow core door 14, rollers 42 for accepting clip 20. The rollers have a spring or tension means for keeping rollers 42 close together so that they can securely accept clip 20.

Viewing FIGS. 1-4 together as representing a preferred embodiment, a user could easily replace or install a modular screen frame 10 by simply lining up pin holes 22 with pins 32 and pushing the modular screen frame 10 into place. Optionally, safety screw 24 can be used for securing the modular screen frame 10 to hollow core door 14.

Other methods of installing or replacing modular screen frame 10 in hollow core door 14 are envisioned. One method not using roller latches and clips would be to simply use regular screws to secure modular screen frame 10 in hollow core door 14. Other fasteners could also be employed such as nails, large staples, or the like.

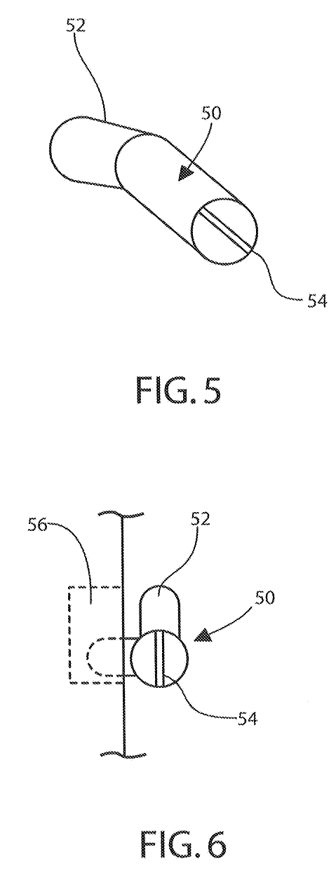

Particular reference is now made to FIG. 5 a detailed perspective view of an L-screw and FIG. 6 a schematic view of an L-screw being used for securing a modular screen frame to a hollow core door. The L-screw 50 with tap 52 and screwdriver slot 54 could be used to secure modular screen frame 10 to hollow core door 14. L-screw 50 could be manufactured into modular screen frame 10 so that a quarter turn of L-screw 50 slide tap 52 into or out of an associated slot 56 in hollow core door 14.

While a presently preferred and various alternative embodiments of the present invention have been described in sufficient detail above to enable a person skilled in the relevant art to make and use the same it should be obvious that various other adaptations and modifications can be envisioned by those persons skilled in such art without departing from either the spirit of the invention or the scope of the appended claims.

What is claimed:

1. A door comprising:
a hollow core,
an opening in said door,
a modular frame for installation into said opening,
wherein said modular frame is installed into said opening by a plurality of fasteners.

2. The door of claim 1, wherein said modular frame holds a mesh screen.

3. The door of claim 1, wherein said modular frame holds a section of glass.

4. The door of claim 1, wherein said modular frame holds a section of acrylic glass.

5. The door of claim 1, wherein said plurality of fasteners comprises at least one L-screw.

6. The door of claim 1, wherein said plurality of fasteners comprises at least one roller latch and at least one clip.

7. The door of claim 1, wherein said plurality of fasteners comprises at least one roller latch, at least one clip, and at least one pin.

8. The door of claim 1, wherein said plurality of fasteners comprises at least one roller latch, at least one clip, at least one screw and at least one pin.

9. The door of claim 1, wherein said modular frame is installed into said opening without tools by placing said modular mesh screen frame into said opening.

10. The door of claim 1, wherein said opening in said door is located in upper half portion of said door.

11. A hollow core door comprising:
an opening in said hollow core door,
a modular mesh screen frame for installation into said opening,
wherein said modular mesh screen frame is installed into said opening by a plurality of fasteners.

12. The door of claim 11, wherein said plurality of fasteners comprises at least one L-screw.

13. The door of claim 11, wherein said plurality of fasteners comprises at least one roller latch and at least one clip.

14. The door of claim 11, wherein said plurality of fasteners comprises at least one roller latch, at least one clip, and at least one pin.

15. The door of claim 11, wherein said plurality of fasteners comprises at least one roller latch, at least one clip, at least one screw and at least one pin.

16. The door of claim 11, wherein said modular mesh screen frame is installed into said opening without tools by placing said modular mesh screen frame into said opening.

17. The door of claim 11, wherein said opening in said door is located in upper half portion of said door.
